(19) United States
(12) Patent Application Publication
(10) Pub. No.: US 2003/0234887 A1
(43) Pub. Date: Dec. 25, 2003

(54) Imaging apparatus with flash light device, imaging method, and program for controlling imaging apparatus

(75) Inventor: Yoshiyuki Kato, Higashiyamato-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/422,461

(22) Filed: Apr. 24, 2003

(30) Foreign Application Priority Data
Apr. 30, 2002 (JP) 2002-128018

(51) Int. Cl. H04N 5/222

(52) U.S. Cl. 348/371

(57) ABSTRACT

A subject against a dark background can be photographed with proper exposure without steadying an imaging apparatus. An exposure time Tb which is effective for reducing hand or body shake, a time lag Tg of a time duration between a time a gain of a gain control amplifier is set and a time when the gain control amplifier initiates operation under such set gain, and a maximum light radiation period Tf of a strobe flash are read out (S101). When a shutter key is half-depressed, a slow synchronizing exposure time Ta is calculated (S103), and a gain value Y (dB) is calculated (S104), which is to be changed during the exposure. When the shutter key is depressed to the full stroke, exposure initiates (S106) and the strobe flash radiates the light at Tf (S107). When a time Tf has passed since the initiation of the exposure (S109, YES), the gain of the gain control amplifier is changed to the gain value Y (dB) (S110). When the time Tb has passed since the initiation of the exposure, the exposure ceases (S112).

### BACKGROUND OF THE INVENTION

The present invention relates to an imaging apparatus with a flash light device, an imaging method, and a program for controlling the imaging apparatus. For taking a picture of a subject against a dark background such as a night scene, an auto flash is generally used, which automatically fires a stroboscopic flash: whenever a sensor decides there is not the light enough to make an appropriate exposure. At firing the stroboscopic flash, a shutter speed is fixed at around one sixtieth (1/60) second to reduce unwanted user camera shake. Then, a picture of the subject within the stroboscopic flash light range will be taken at an adequate exposure, but the background portion in the photograph where poor flash light reaches can not be taken at a proper exposure, resulting in a rather dark photograph bearing no atmosphere at the time when the picture is taken.

Meanwhile, an improved method for taking a shot, so called a slow synchronizing mode, has been proposed and is a favorite feature, in which Auto Exposure system (AE) automatically sets a proper exposure time (a shutter speed) at firing the stroboscopic flash light. The slow synchronizing mode allows the background portion in the photograph where the stroboscopic flash light hardly reaches to be taken at an adequate exposure, and therefore a photograph of the subject representing an atmosphere at the time of taking a shot is available. The slow synchronizing mode sets a comparably long exposure time for taking a picture of the subject at dark in accordance with darkness of the background, and user camera shake can be easily caused during such a long exposure time. Therefore, the user is often required to use a tripod to steady the camera for taking a shot in the slow synchronizing mode. A compact camera with the tripod fixed is inconvenient for the user to use and is prevented from showing its feature of easy-to-use.

### SUMMARY OF THE INVENTION

It is, an aspect of the present invention to provide an imaging apparatus, which comprises a flash-light device responsive to initiation of exposure for radiating the flash light against a subject, an imaging device on which an image of the subject is focused-for generating an image signal of the subject, an amplifier for amplifying the image signal of the subject generated by the imaging-device, a data generator for creating image data based on the image signal of a predetermined exposure time amplified by the amplifier, a storage for storing the image data created by the data generator, and a controller for controlling operation of the amplifier within the exposure time-to set a gain higher than the predetermined gain, when the flash light device ceases radiating the flash light. It is another aspect of the invention to provide a method of taking a picture, which comprises the steps of radiating light in response to initiation of exposure, amplifying an image signal output from an imaging device on which an image is focused, generating image data based on the amplified image signal within an exposure time, storing the generated image data in a storage, and controlling an amplifying gain within the exposure time and after cease of the flash light radiation to set a level higher than a level during the flash light radiation.

### BREIF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, will serve to explain the principle of the invention.

FIG. 1 is a block diagram of an electronic still camera according to a first embodiment of the invention;

FIG. 2 is a timing chart illustrating operation performed commonly in the-first and second embodiments;

FIG. 3 is a flow chart of processes performed in the first embodiment;

FIG. 4 is a block diagram of an electronic still camera according to a second embodiment of the invention; and

FIG. 5 is a flow chart of processes performed in the second embodiment.

### DESCRIPTION OF THE PREFERRED EMBODIMENTS

[First Embodiment]

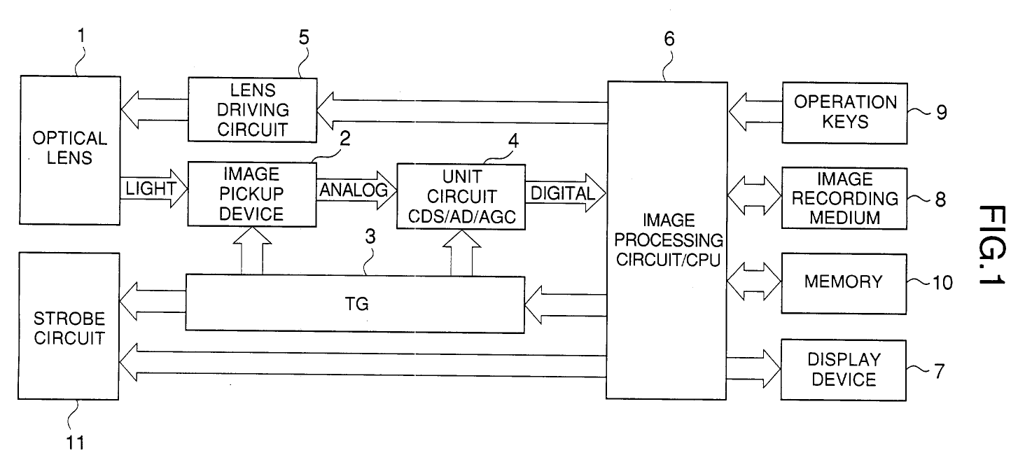

Now, a first embodiment of the present invention will: be described in detail with reference to the-accompanying drawings. FIG. 1 is a block diagram showing a circuit configuration of an electronic still camera according to the first embodiment of the invention. The electronic still camera comprises an optical lens 1, an image pickup device 2, where an image of a subject is focused through the optical lens 1, a timing signal generator 3 (TG 3) for driving the image pickup device 2, and a unit circuit 4. The unit circuit 4 includes CDS for holding an image signal output from the image pickup device 2, a gain control amplifier (AGC) for amplifying the image signal, and an analog/digital converter (AD) for converting the amplified image signal into a digital signal. The optical lens 1 is supported by a lens driving mechanism including an automatically focusing motor (AF motor) and a lens driving circuit 5. The lens driving circuit 4 is controlled by an image processing circuit/CPU 6 to drive the optical lens 1 to move along its optical axis, whereby an image of a subject is focused on the image pickup device 2. In the AE control mode, the image pickup device 2 is driven by the TG 3 based on a shutter pulse sent from the image processing circuit/CPU 6, whereby a charge storage time of the image pickup device 2 is controlled. As describe above, an electronic shutter function is performed. The image processing circuit/CPU 6 has various functions for processing signals as well as an image processing function. The image processing circuit/CPU 6 generates a video signal based on the digital image signal output from the unit circuit 4, whereby an image of the subject picked up by the image pickup device 2 is displayed as a through image on a display device 7 such as a TFT liquid crystal monitor. In an image pickup mode, the image processing circuit/CPU 6 compresses the image signal to generate an image file in a predetermined format and stores the image file on an image recording medium 8 such as a flash memory. In a reproducing mode, the image processing circuit/CPU 6 expands the image file recorded on the image recording medium 8 to display the image of the subject on the display device 7.

Further, the image processing circuit/CPU 6 is connected with an operation key portion 9 including a shutter key and other various keys, a memory 10 and a strobe circuit 11. The memory 10 comprises a program ROM on which an operation program is recorded for performing processes in accordance with a flow chart, as will be set forth later. The operation program runs on the image processing circuit/CPU 6 to control various portions and to process various data. The strobe circuit 11 is provided with flash light means. The image processing circuit/CPU 6 sends a strobe light signal to the strobe circuit 11 through the TG 3, and the strobe circuit 11 makes the flash light means radiate light only within a time period while the strobe light signal is being supplied thereto. A light volume is proportional to a time period during which the flash light means radiates the light. At this time, the image of the subject in the flash light or in the illumination is focused on the image pickup device 2 through the optical lens 1, and the image pickup device 2 outputs a signal. The signal from the image pickup device 2 is subjected to a sampling process, amplified and converted into a digital signal at the unit circuit 4, and further the digital signal is supplied to the image processing circuit/CPU 6, where the digital signal is converted to a luminance signal, which is further subjected to a luminance integral and a histogram process.

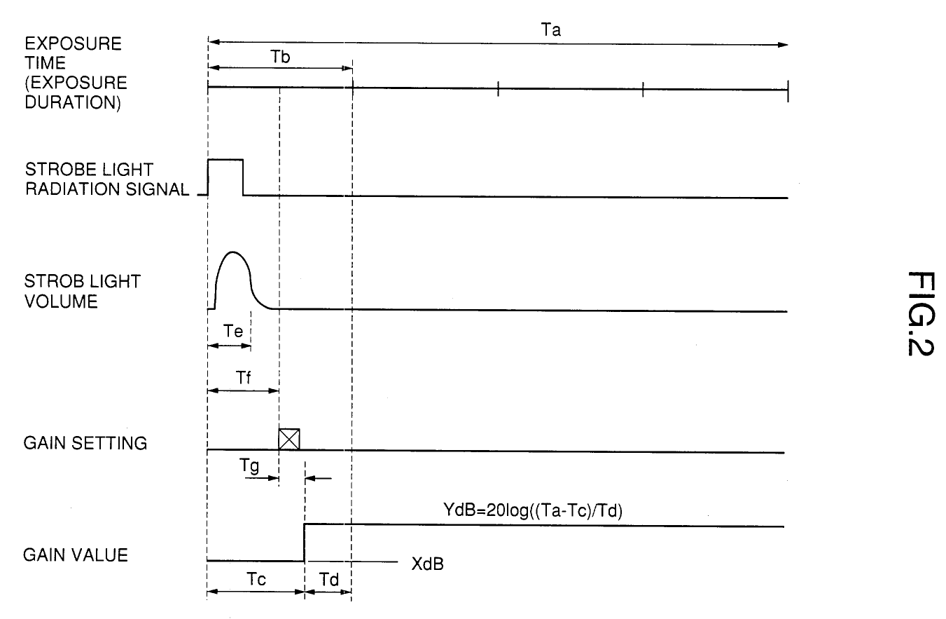

Further, on the memory 10 are stored, in addition tot the operation program, an exposure time Tb, for instance 1/60 second, which is, effective for reducing hand or body shake, a time lag Tg of a period between a time when the image processing circuit/CPU 6 sets a gain regulation and a time when the, gain control amplifier (AGC) of the unit circuit 4 works under the gain regulation set by the image processing circuit/CPU 6, and a time Tf of the maximum light radiation period of the strobe light. Relationships among time data Ta, Tb, Tc, Td, Te, Tf and Tg are illustrated in FIG. 2.

The memory 10 may comprise a rewritable memory, on which data including a program can be rewritten, if necessary. The data and the program, whole or a part, may be stored in the image recording medium 8.

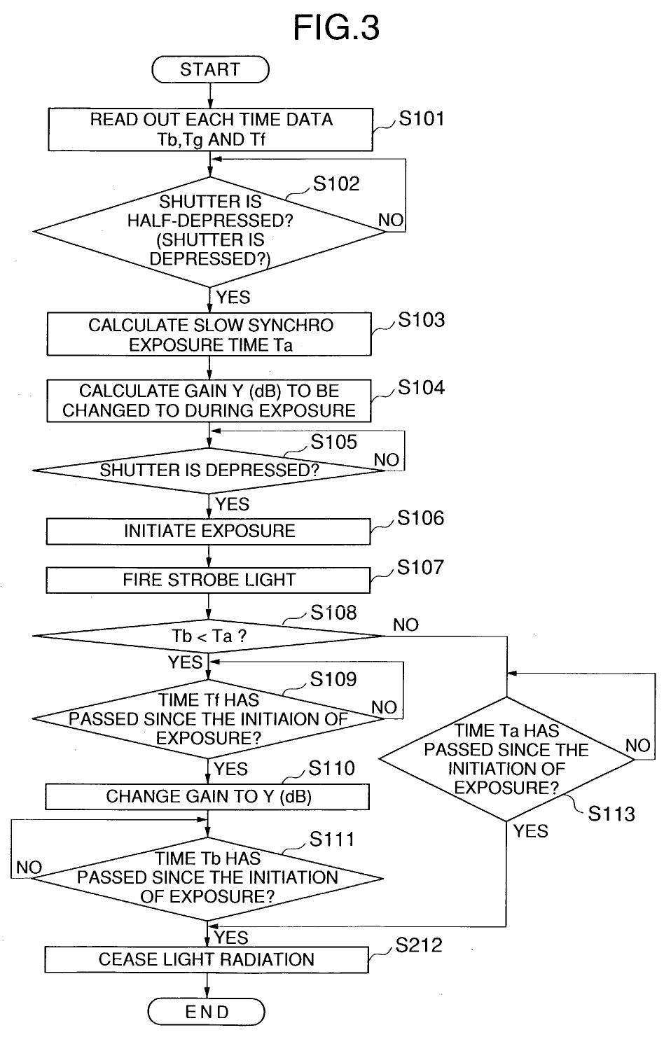

An image-pickup operation of the still camera having the above structure will be described with reference to the timing chart of FIG. 2 and the flowchart of FIG. 3. The flow chart of FIG. 3 shows the operation performed by the electronic still camera in an image capture mode (the image picking-up mode) in which a through image is displayed on the display device 7. At first, the camera is in a state waiting for an image capture operation.

The image processing circuit/CPU 6 reads out from the memory 10 the exposure time Tb, which is effective for reducing hand or body shake, the time lag Tg of a period between the time when the image processing circuit/CPU 6 sets a gain regulation and the time when the gain control amplifier (AGC) of the unit circuit 4 works under the gain regulation set by the image processing circuit/CPU 6, and the time Tf of the maximum light radiation period of the strobe light at Step S101. Then, it is judged at-Step S102 if a shutter key is half-depressed or it is judged if the shutter key is depressed to the full extent (in the event of the camera having no half-depressing function). When it is determined that the shutter key has been depressed, a slow synchronizing exposure time Ta is calculated at Step S103. The synchronizing exposure time Ta is calculated by using a conventional well known calculation method similar to a calculation of a slow synchronizing exposure time in a slow synchronizing mode. When, taking a picture by using the calculated synchronizing exposure time Ta, an appropriate exposure is realized in the slow synchronizing mode (a slow synchronizing photograph).

A gain value Y (dB) for an, exposure which is changed on the way will be calculated at Step S104 by using the following equation,

Y=20 log ((Ta−Tc)/Td)

where Ta is the slow synchronizing exposure time. As shown in FIG. 2, a time Tc represents a time duration between a time when the exposure is initated and a time when the gain of the AGC is changed, and is expressed by the following equation,

Tc=Tf+Tg

where Tf is the predetermined maximum light radiation period of the strobe light, and Tg is the period between the time when the image processing circuit/CPU 6 sets the gain regulation and the time when the gain control amplifier (AGC) of the unit circuit 4 works under the gain regulation set by the image processing circuit/CPU 6.

A time Td represents an exposure time after the AGC has changed the gain, and is given by the following equation,

Td=Tb−Tc

where Tb is the exposure time which is effective for reducing hand or body shake, and Tc is a time duration between the time when the exposure is initated and the time when the gain of the AGC is changed.

Then, it is judged at Step S105 if the shutter key is depressed to the full extent, or it is judged if the shutter key has been depressed twice, in the event the camera has no half depressing function. When it is determined that the shutter key has been depressed, the- exposure initiates at Step S106, and the strobe light keeps radiating for the time duration of Tf at Step S107.

Further, it is judged at Step S108 if Tb<Ta is true. When NO, or when Tb is equal to or longer than Ta, this means that the slow synchronizing exposure time Ta calculated at Step S103 is equal to or shorter than the exposure time Tb which is effective for reducing the hand or body shake. In this situation, since the hand or body shake is avoided without processes performed at Step S109 and S110, and a picture of the subject against a dark, background can be taken in proper lighting conditions, it is judged at Step S113 if the time Ta has passed since the initiation of exposure. If YES at Step S113, the process advances to Step S112.

Meanwhile, if YES at Step S108, or if Tb<Ta is true, then this means that the slow synchronizing exposure time Ta is longer than the time Tb which is effective for reducing the hand or body shake. In this situation, while taking a picture with a camera set to the slow synchronizing exposure time Ta, the hand or body shake will be possibly invited, and if a picture is taken using the exposure time Tb, which is effective for avoiding the hand or body shake, the subject against a dark background is not photographed in the proper exposure conditions.

At Step S109, it is judged if the predetermined maximum light radiation period of the strobe light Tf has passed since the initiation of the exposure. When YES, or it is determined that the predetermined maximum light radiation period of the strobe light Tf has passed since the initiation of the exposure the time, the image processing circuit/CPU 6 changes at Step S110 the gain regulation of the AGC of the unit circuit 4 to the gain value Y (dB) calculated at Step S104. Then, the image signal output from the image pickup device 2 is amplified by the AGC at the gain value Y after the time Tg has passed since the gain regulation of the AGC was changed.

Further, it is judged at Step S111 if the time Tb has passed since the initiation of the exposure. When YES, the exposure is ceased at Step S112. Then, the image processing circuit/CPU 6 compresses the digital image signal supplied from the unit circuit 4.to generate an image file in a certain format, storing the same in the image recording medium 8.

The image of the image: file stored in the image recording medium 8 has been processed at Steps S111, and S112, and photographed using the exposure time Tb, which is effective for reducing the hand or body shake, and makes available a sharp photograph without-the effect of the hand or body shake. Further, the image has been obtained by firing the strobe flash at the time Tf at step S107, and the signal of the image is amplified by the AGC with the gain value Y(dB) set at Steps S109 and S110. As described above, the subject which the strobe light reaches is photographed in the proper exposure situations, and the background in the photograph which less strobe light reaches is realized in an average brightness as if the background portion is taken at a rather long exposure setting. Using the embodiment of the invention, the subject against a dark background may be photographed with a proper exposure without steadying the camera, and an image representing the atmosphere at taking a shot may be obtained.

In the first embodiment of the invention, the judgment is made at Step S109 using the time of Tf representing the time when the strobe light ceases the radiation completely, but such judgment may be made using the time of Te (Te<Tf): representing -the time when the strobe light ceases the radiation substantially. An equation Tc=Tf may be used in place of the equation Tc=Tf+Tg. What is important is to change the gain Y (dB) of the AGC immediately after the cease of radiation of the strobe flash.

[Second Embodiment]

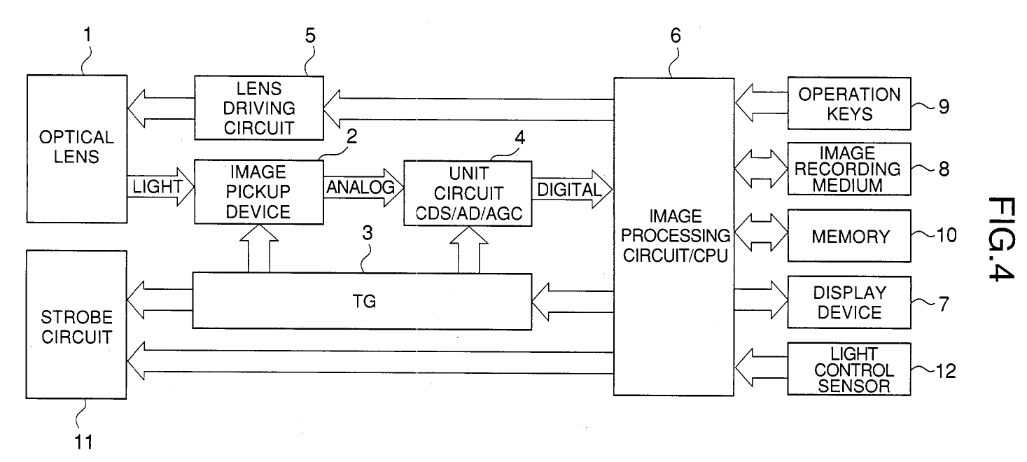

FIG. 4 is a block- diagram showing a electric circuit configuration of an electronic still camera according to the second embodiment, of the invention. The still camera of the second embodiment is different from the camera of the first embodiment only in that a light control sensor is installed in the second embodiment. The light control sensor is used for detecting brightness. On the memory 10 are stored the exposure time Tb, which is effective for reducing hand or body shake, and the time lag Tg of a period between a time when the image processing circuit/CPU 6 sets a gain regulation and a time when the gain control amplifier (AGC) of the unit circuit 4 works under the gain regulation set by the image processing circuit/CPU 6 in addition to the operation program. But the time Tf of the light radiation period of the strobe light is not stored on the memory 10. The light radiation period Tf is set based on the brightness detected by the light control sensor 12.

The electronic still camera of the second embodiment has the substantially same structure as the first, embodiment, and therefore detailed description thereof will be omitted.

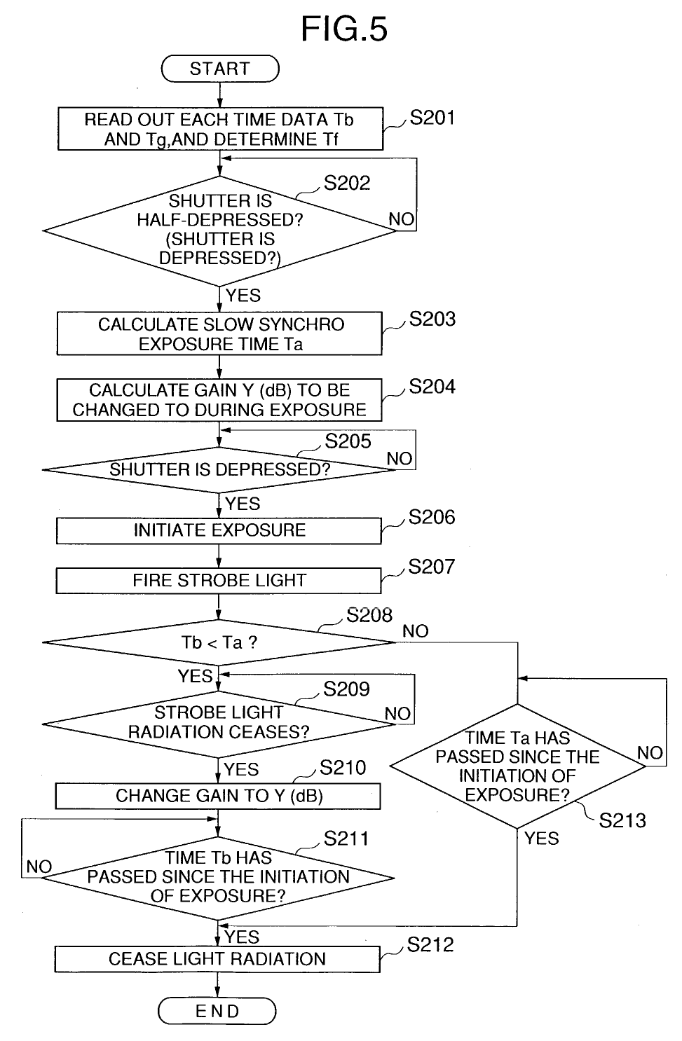

Operation to be performed by the electronic still camera in an image picking-up mode of the second embodiment will be described with reference to the timing chart of FIG. 2 and the flowchart of FIG. 5. The flow chart of FIG. 5 shows the operation performed by the electronic still camera in an image capture mode (that is, in the image picking-up mode), in which a through image is displayed on the display device 7 as in the similar manner to the operation in the first embodiment. At first, the camera is in a state waiting for an image capture operation.

The image processing circuit/CPU 6 reads out from the memory 10 the exposure time Tb, which is effective for reducing hand or body shake, and the time lag Tg of a period between the time when the image processing circuit/CPU 6 sets a gain regulation and the time when the gain control amplifier (AGC) of the unit circuit 4 works, under the gain regulation set by the image processing circuit/CPU 6, and determines based on the environmental brightness detected by the light control sensor 12 a time duration (or a strobe light radiation period) Tf in which the strobe flash keeps radiating the light at Step S201.

At Steps S202 through S208 and S213, the same processes as performed in the first embodiment at Steps S102 through S108 and S113 are performed in the second embodiment. Further it is judged at Step S209 if the strobe flash has ceased the flash light radiation based on the detection made by the light control sensor 12. When the flash light radiation has ceased, the same processes as performed at Steps S110 through S112 in the first embodiment are performed at Steps S210 through S212 in the second embodiment.

In the second embodiment, a picture can be taken with no influence of hand or body shake, and the subject in the flash light is photographed at a proper exposure and the background where no flash light reaches can be also photographed sharp with a proper exposure, resulting in a sharp photograph having an atmosphere of taking a shot. The image file of the above photograph can be stored in the image recording medium 8 in the second embodiment. In the second embodiment, it is judged at Step S209 if the strobe flash has ceased the light radiation based on the detection made by the detecting means. But since the radiation time Tf of the strobe flash is set previously, it may be judged if the time Tf has passed since the initiation of exposure in the second embodiment similarly as in the first embodiment. The flash light means of the strobe circuit 11 may comprise a strobe bulb, and light emitting means such as a light emitting diode.

What is claimed is:

1. An imaging apparatus, comprising:
a flash light device responsive to initiation of exposure for radiating flash light against a subject;
an imaging device on which an image of the subject is focused, for generating an image signal of the subject;
an amplifier for amplifying at a predetermined gain the image signal of the subject generated by the imaging device;
a data generator for creating image data based on the image signal of a predetermined exposure time amplified by the amplifier;
a storage for storing the image data created by the data generator; and
a controller for controlling operation of the amplifier within the exposure time to set a gain higher than the predetermined gain, when the flash light device ceases radiating the flash light.

2. The imaging apparatus according to claim 1, wherein the controller calculates the gain of the amplifier after the cease of the flash light radiation based on the exposure time in a slow synchronizing mode to set a higher gain to the amplifier.

3. The imaging apparatus according to claim 1, wherein the exposure time is a time duration predetermined for reducing hand and body shake.

4. The imaging apparatus according to claim 1, wherein the controller increases the gain of the amplifier after a predetermined time of the light radiation by the flash light device has passed.

5. The imaging apparatus according to claim 1, further comprising: a detector for detecting the cease of light radiation by the flash light device, and wherein the controller increases the gain of the amplifier based on the detection made by the detector.

6. A method of taking a picture comprising the steps of:
radiating light in response to initiation of exposure;
amplifying an image signal output from an imaging device on which an image is focused;
generating image data based on the amplified image signal within an exposure time;
storing the generated image data in a storage; and
controlling an amplifying gain within the exposure time and after cease of the flash light radiation to set a level higher than during the flash light radiation.

7. The method of taking a picture according to claim 6, wherein, at the step of control, the gain of the amplifier for a time after the cease of the flash light radiation is calculated based on the exposure time in a slow synchronizing mode to increase the gain of the amplifier.

8. The method of taking a picture according to claim 6, wherein the exposure time is a time duration predetermined for reducing hand and body shake.

9. The method of taking a picture according to claim 6, wherein, at the step of control, the gain of the amplifier is increased for a time after a predetermined time of the flash light radiation has passed.

10. The method of taking a picture according to claim 6, further comprising the step of detecting the cease of the light radiation, and wherein, at the step of control, the gain of the amplification is increased based on the detection made at the step of detection.

11. In an imaging apparatus with a flash light device, which comprises a flash light radiating device for radiating flash light in response to initiation of exposure, an imaging device on which an image is focused for generating an image signal, an amplifier for amplifying the image signal output from the imaging device, a data generator for generating image data based on the image signal within an exposure time amplified by the amplifier, a storage for storing the image data generated by the data generating means, and a computer, a control program installed on the imaging apparatus comprising a procedure for making the computer control a gain of the amplifier within the exposure time and after cease of flash light radiation by the flash light deice to set a level higher than during the flash light radiation by the flash light device.
